(19) United States
(12) Patent Application Publication
(10) Pub. No.: US 2015/0229239 A1
(43) Pub. Date: Aug. 13, 2015

(54) INERTIAL DRIVE ACTUATOR

(71) Applicant: OLYMPUS CORPORATION, Tokyo (JP)

(72) Inventor: Masaya TAKAHASHI, Tokyo (JP)

(73) Assignee: OLYMPUS CORPORATION, Tokyo (JP)

(21) Appl. No.: 14/692,035

(22) Filed: Apr. 21, 2015

Related U.S. Application Data
(63) Continuation of application No. PCT/JP2013/070582, filed on Jul. 30, 2013.

(30) Foreign Application Priority Data
Oct. 23, 2012 (JP) 2012-233627

(51) Int. Cl. H02N 2/06; H02N 2/02

(52) U.S. Cl. CPC H02N 2/062; H02N 2/026

(57) ABSTRACT

An inertial drive actuator includes a displacement unit that generates a small displacement in a first direction and in a second direction opposite to the first direction, a plurality of coils that generate a magnetic flux in a direction different from the displacement unit, a mover having a surface facing at least one surface of the plurality of coils and a first yoke that concentrates the magnetic flux generated by the coils to a predetermined location, a detection unit that detects electrical signals of the plurality of coils that represent changes in the magnetic flux in the neighborhood of the coils depending on positional relationship between the mover and the plurality of coils, and a determination unit that determines the position of the mover based on an output of the detection unit.

### CROSS-REFERENCE TO RELATED APPLICATION

The present application is a continuation application of PCT/JP2013/070582 filed on Jul. 30, 2013 which is based upon and claims the benefit of priority from Japanese Patent Application No. 2012-233627 filed on Oct. 23, 2012; the entire contents of which are incorporated herein by reference.

### BACKGROUND OF THE INVENTION

1. Field of the Invention

The present invention relates to an inertial drive actuator.

2. Description of the Related Art

There is a known actuator that supplies saw-tooth driving pulses to an electromechanical transducer coupled with a drive shaft to shift the drive shaft in the axial direction, thereby moving a movable member frictionally coupled with the drive shaft in the axial direction. Such an actuator will be hereinafter referred to as an “inertial drive actuator”. This type of actuator is disclosed in, for example, Japanese Patent Application Laid-Open No. 2009-177974.

In conventional inertial drive actuators, one end of a piezoelectric element is fixed to a fixed member and the other end of the piezoelectric element is fixed to an end of a vibration plate. A mover that can move in the direction of vibration of the piezoelectric element is arranged on the vibration plate. The fixed plate or the vibration plate are made of a magnetic material (e.g. iron or stainless steel having magnetism), and an attracting part is also made of a magnetic material. A magnetic field is generated by supplying electrical current to a coil. The magnetic field thus generated also generates a magnetic field in the attracting part. The magnetic field generated in the attracting part causes the vibration plate or the fixed member made of a magnetic material to provide a magnetic attraction force, which brings the mover and the vibration plate into close contact with each other, so that a frictional force acts between them.

### SUMMARY OF THE INVENTION

An inertial drive actuator according to the present invention comprises a displacement unit that generates a small displacement in a first direction and in a second direction opposite to the first direction, a plurality of coils that generate a magnetic flux in a direction different from the displacement unit, a mover having a surface facing at least one surface of the plurality of coils and a first yoke that concentrates the magnetic flux generated by the coils to a predetermined location, a detection unit that detects electrical signals of the plurality of coils that represent changes in the magnetic flux in the neighborhood of the coils depending on positional relationship between the mover and the plurality of coils, and a determination unit that determines the position of the mover based on an output of the detection unit.

### BRIEF DESCRIPTION OF THE DRAWINGS

FIG. 1A is a top view of an inertial drive actuator according to a first embodiment;

FIG. 1B is a cross sectional view taken on line A-A in FIG. 1A;

FIG. 1C is a cross sectional view taken on line B-B in FIG. 1A;

FIG. 2A is a top view of an inertial drive actuator according to a second embodiment;

FIG. 2B is a cross sectional view taken on line A-A in FIG. 2A;

FIG. 2C is a cross sectional view taken on line B-B in FIG. 2A;

FIG. 3A is a top view of an inertial drive actuator according to a third embodiment;

FIG. 3B is a cross sectional view taken on line A-A in FIG. 3A;

FIG. 3C is a cross sectional view taken on line B-B in FIG. 3A;

FIG. 4A is a top view of an inertial drive actuator according to a fourth embodiment;

FIG. 4B is a cross sectional view taken on line A-A in FIG. 4A;

FIG. 4C is a cross sectional view taken on line B-B in FIG. 4A;

FIG. 5A is a top view of an inertial drive actuator according to a fifth embodiment;

FIG. 5B is a cross sectional view taken on line A-A in FIG. 5A;

FIG. 5C is a cross sectional view taken on line B-B in FIG. 5A;

FIGS. 6A, 6B, and 6C are diagrams illustrating the change in the position of a mover and the change in the magnetic flux;

FIGS. 7A and 7B are graphs showing relationship between the position of the mover and the change in the magnetic flux;

FIG. 8A is a diagram illustrating a movable range of the mover;

FIG. 8B is a graph showing the change in the magnetic flux; FIG. 9A is a diagram showing a variation of the arrangement of coils; and

FIG. 9B is a diagram showing another variation of the arrangement of coils.

### DETAILED DESCRIPTION OF THE INVENTION

In the following, embodiments of the inertial drive actuator according to the present invention will be described in detail with reference to the drawings. It should be noted that the present invention is not limited by the embodiments.

### First Embodiment

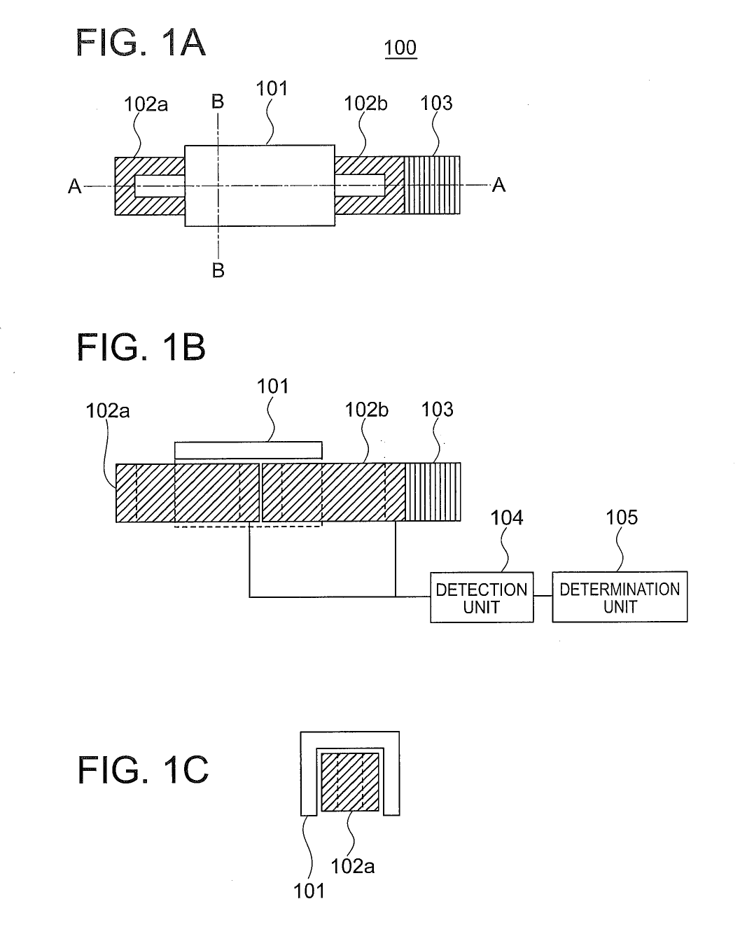

An inertial drive actuator according to a first embodiment will be described with reference to FIGS. 1A, 1B, and 1C.

An inertial drive actuator 100 has a mover 101, a plurality of coils, e.g. two coils 102a, 102b, a piezoelectric element 103 (shifting unit), a detection unit 104, and a determination unit 105.

The piezoelectric element 103 generates small displacements in a first direction and a second direction opposite to the first direction.

The two coils 102a, 102b generate a magnetic flux in directions different from the directions of displacements of the piezoelectric element 103.

The mover 101 has a surface that faces at least one surface of the plurality of coils.

The mover 101 has a first yoke, which concentrates the magnetic flux generated by the coils 102a, 102b to a predetermined location.

The detection unit 104 detects electrical signals of the plurality of coils 102a, 102b, which represent changes in the magnetic flux in the neighborhood of the respective coils 102a, 102b, which depend on the positional relationship between the mover and the plurality of coils 102a, 102b.

The determination unit 105 determines the position of the mover 101 on the basis of the output of the detection unit 104.

The above-described configuration provides the following effects:
The amount of main magnetic flux in the neighborhood of each coil 102a, 102b changes with the positional relationship between each coil 102a, 102b and the mover 101, where the main magnetic flux is defined to be the magnetic flux that runs along a magnetic path passing through the interior of the coils 102a, 102b and the mover 101;
The change in the amount of main magnetic flux in the neighborhood of each coil 102a, 102b causes a change in the electrical signal (or impedance) of each coil 102a, 102b; and
The position of the mover 101 can be determined by computation based on the electrical signals of the coils 102a, 102b.

The structure of the inertial drive actuator 100 according to the first embodiment will further be described in detail.

FIG. 1A is a top view of the inertial drive actuator 100 according to the first embodiment, FIG. 1B is a cross sectional view taken on line A-A in FIG. 1A, and FIG. 1C is a cross sectional view taken on line B-B in FIG. 1A.

As described above, the inertial drive actuator 100 has the coils 102a, 102b, the piezoelectric element 103, the mover 101, the detection unit 104, and the determination unit 105. The mover 101 is a magnetic member made of a magnetic material. The magnetic member serves as a yoke (first yoke) that closes the magnetic flux generated by the coils 102a, 102b.

In this and all the embodiments described in the following, it is assumed that the mover 101 is made of a magnetic material in its entirety. In cases where the mover 101 has both a magnetic portion and a non-magnetic portion, a portion of the mover 101 may be regarded as a magnetic part of the mover 101.

The actuator 100 has two coils 102a, 102b. The coils 102a, 102b are arranged in series along the direction same as the direction in which the mover 101 is driven.

This configuration provides the following advantageous effects:
The electrical signals of the respective coils 102a, 102b show respective changes depending on the position of the mover 101; and
Arranging the coils 102a, 102b along the driving direction of the mover 101 prevents an increase in the size of the inertial drive actuator in directions perpendicular to the driving direction of the mover 101 and leads to size reduction of the inertial drive actuator.

The coils 102a, 102b are connected to the detection unit 104. The detection unit 104 detects electrical output signals of the coils 102a, 102b. The determination unit 105 determines the position of the mover 101 on the basis of an output from the detection unit 104.

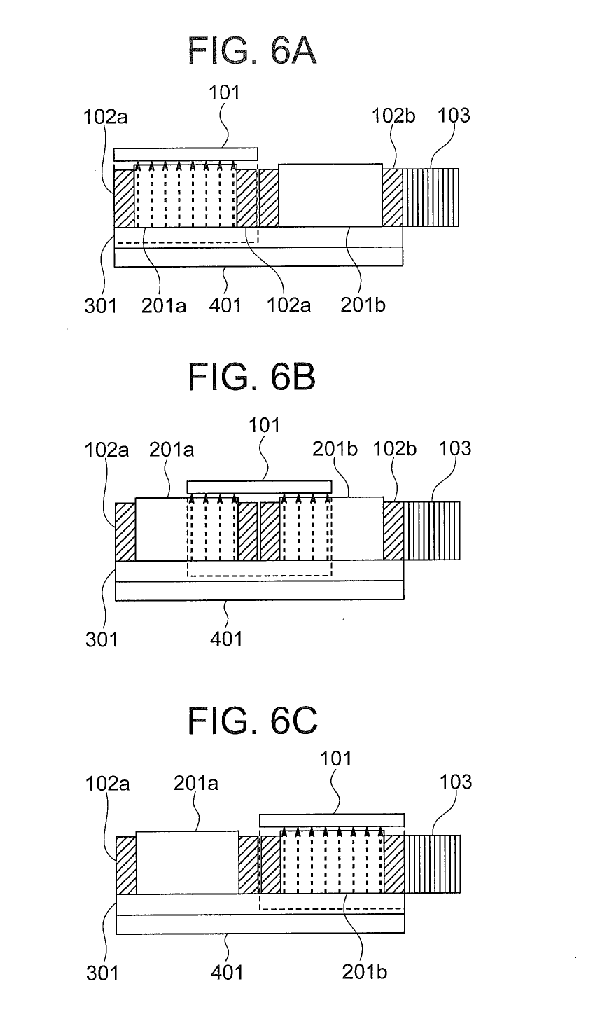

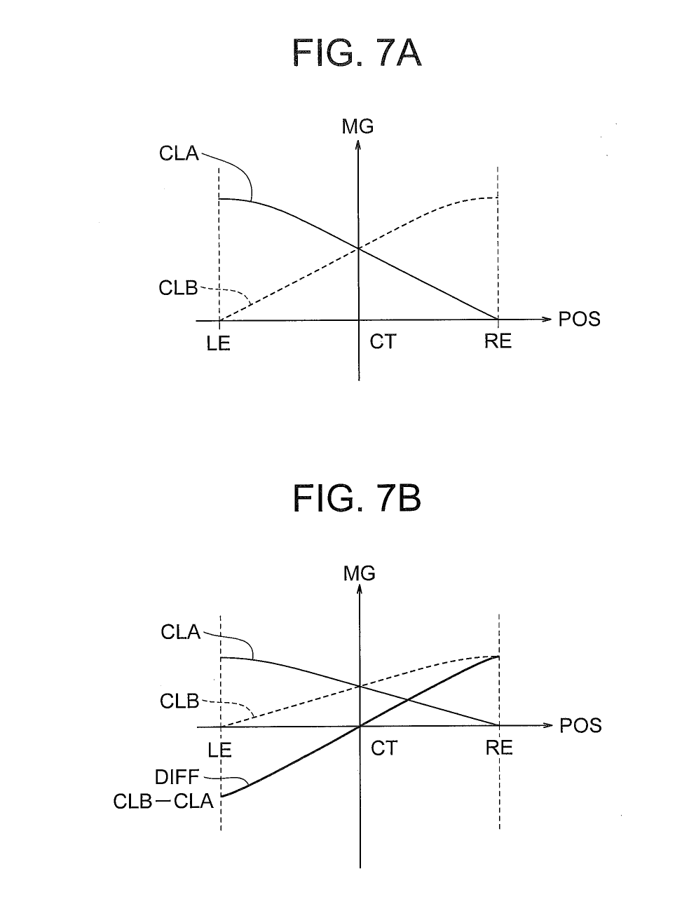

Relationship between the position of the mover 101 and the electrical signals of the coils 102a, 102b will be described later with reference to FIGS. 6 and 7.

The amount of magnetic flux generated by the coils 102a, 102b and passing through the mover 101 changes depending on the position of the mover 101. Since the magnetic flux passing through the mover 101 affects the driving of the mover 101 and determination of the position of the mover 101, the magnetic flux passing through the mover 101 is called the main magnetic flux. The larger the amount of magnetic flux passing through the mover 101 is, the larger the resistance and the inductance of the coils 102a, 102b become due to the effect of back electromotive force.

Therefore, the position of the mover 101 can be estimated by measuring the impedance of the coils 102a, 102b.

In other words, the detection unit 104 measures the impedance of the coils 102a, 102b. The determination unit 105 determines the position on the basis of the output signal from the detection unit 104, which represents the impedance of the coils 102a, 102b.

Moreover, the determination unit 105 can determine not only the position but also the moving direction of the mover 101 by comparing the output signal from the detection unit 104 with the output signal just moments before.

Furthermore, it is possible to perform position-control driving by feeding information of the position of the mover 101 determined by the determination unit 105 back to an actuator driving circuit (not shown).

Consequently, the following advantageous effects are provided:
The position of the mover can be determined by measuring the real part (resistance) of the impedance;
The position of the mover can be determined by measuring the imaginary part (inductance) of the impedance;
The position of the mover can be determined by measuring the magnitude of the impedance; and
Since temperature-dependency of the inductance is small, measuring the inductance is effective in view of temperature variations.

### Second Embodiment

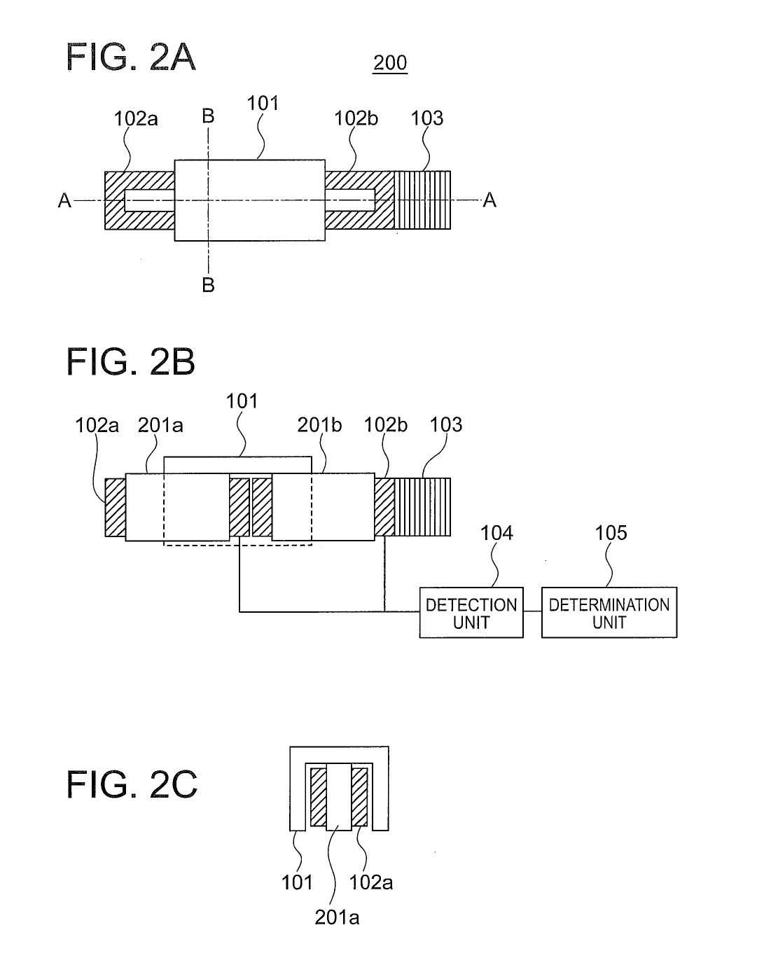

In the following, an internal drive actuator 200 according to a second embodiment will be described with reference to FIGS. 2A, 2B, and 2C. Components same as those in the first embodiment are denoted by the same reference numerals to eliminate redundant descriptions.

The configuration of this embodiment differs from that shown in FIG. 1 in that cores 201a, 201b (second yokes) are additionally provided inside the coils 102a, 102b. The cores 201a, 201b increase the amount of the magnetic flux generated by the coils 102a, 102b.

Consequently, the following advantageous effects are provided:
Providing the cores of the coils increases the change in the magnetic flux with the change in the location;
The detection sensitivity is enhanced; and
Deformation of the coils can be prevented.

The intensity of the output signals of the coils 102a, 102b representing the location of the mover 101 is enhanced. Consequently, the sensitivity in detecting the position of the mover 101 is improved. Relationship between the position of the mover 101 and the electrical signals of the coils 102a, 102b will be described later with reference to FIGS. 6 and 7.

Referring to FIG. 2A, the cores 201a, 201b exist only inside the respective coils 102a, 102b and do not extend outside the coils 102a, 102b (with respect to horizontal and depth directions of the drawing sheet).

Alternatively, the cores 201a, 201b may be arranged to extend outside the respective coils 102a, 102b up to the proximity of the bottom of the mover 101. For example, the core may have a T-shape. This arrangement enhances the efficiency of closing of the magnetic flux of the coils 102a, 102b through the mover 101.

### Third Embodiment

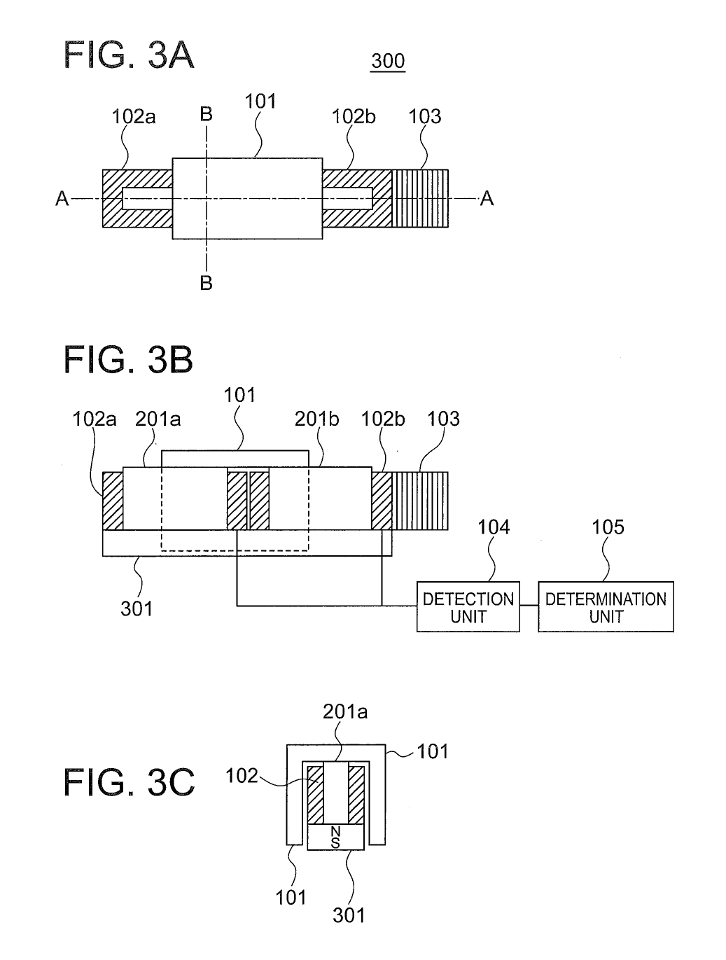

An inertial drive actuator 300 according to a third embodiment will be described with reference to FIGS. 3A, 3B, and 3C. Components same as those in the above-described embodiments are denoted by the same reference numerals to eliminate redundant descriptions.

In this embodiment, a magnet 301 arranged below the cores 201a, 201b or the coils 102a, 102b is added to the actuator of the above-described second embodiment.

The magnet 301 always generates a magnetic flux. Consequently, there is a closed magnetic path of the magnetic flux through the mover 101 like that of the magnetic flux generated by the coils 102a, 102b, even when the coils 102a, 102b are not generating a magnetic field.

Consequently, a force always acts on the mover 101 in the direction of the coils 102a, 102b, so that the mover 101 is retained. Since the amount of magnetic flux passing through the mover 101 is increased by the magnetic flux generated by the magnet 301, the sensitivity in detecting the position of the mover 101 is improved. Relationship between the position of the mover 101 and the electrical signals of the coils 102a, 102b will be described later with reference to FIGS. 6 and 7.

### Fourth Embodiment

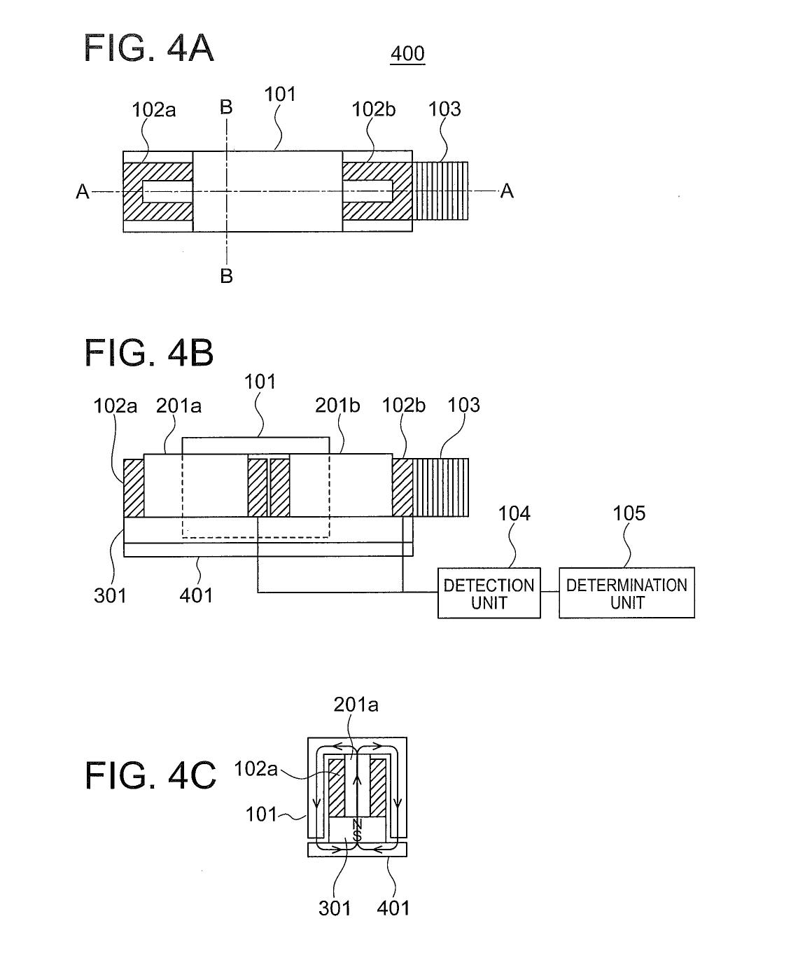

An inertial drive actuator 400 according to a fourth embodiment will be described with reference to FIGS. 4A, 4B, and 4C. Components same as those in the above-described embodiments are denoted by the same reference numerals to eliminate redundant descriptions.

In this embodiment, a yoke 401 (third yoke) made of a magnetic material arranged below the magnet 301 is added to the actuator of the above-described third embodiment. Providing the yoke 401 increases the amount of magnetic flux passing through the magnetic path of the magnetic flux generated by the coils 102a, 102b and the magnet 301 through the mover 101.

Consequently, the following advantageous effects are provided:
The mover can be retained always;
The change in the magnetic flux depending on the position of the mover is increased by the magnetic flux generated by the magnet; and
The detection sensitivity is enhanced.

### Fifth Embodiment

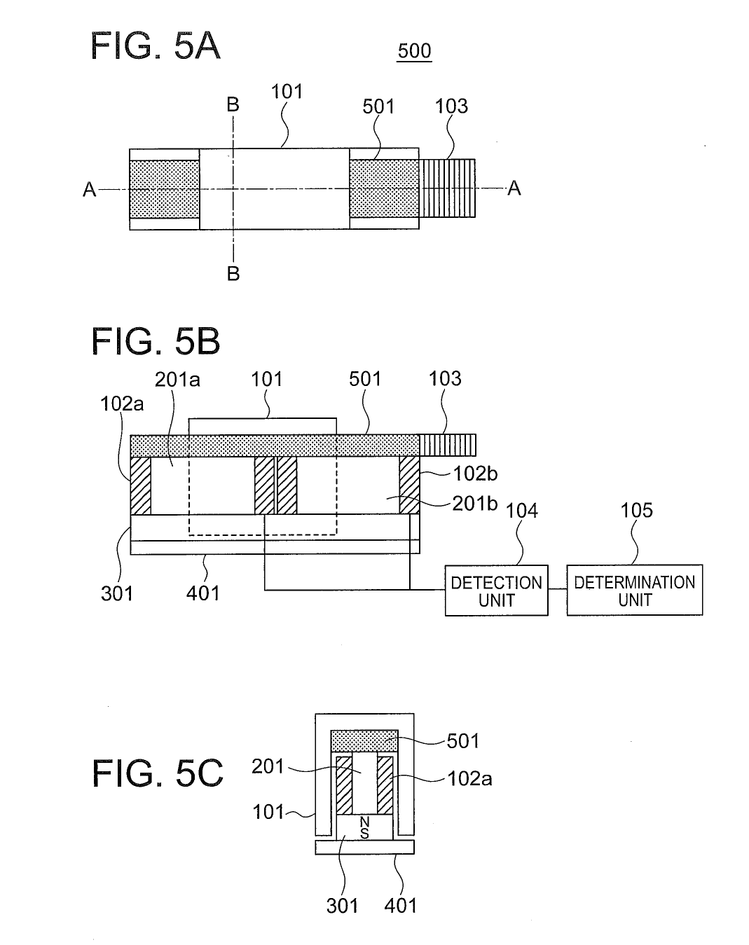

An inertial drive actuator 500 according to a fifth embodiment will be described with reference to FIGS. 5A, 5B, and 5C. Components same as those in the above-described embodiments are denoted by the same reference numerals to eliminate redundant descriptions.

In this embodiment, a vibration plate 501 arranged between the mover 101 and the coils 102a, 102b is added to the actuator of the above-described fourth embodiment.

In this embodiment, the part that is minutely vibrated by the piezoelectric element 103 is only the vibration plate 501. Therefore, the size of the piezoelectric element 103 used may be made smaller. This is expected to lead to a reduction in the power consumption of the piezoelectric element 103 and a reduction in the generated heat. Moreover, since the coils 102a, 102b and the piezoelectric element 103 are not in contact with each other, the coils 102a, 102b can be protected.

Consequently, the following advantageous effects can be provided by this configuration:
The size of the vibrating part can be made smaller;
Since the size of the piezoelectric element (in the case where the displacement unit is a piezoelectric element, which may be replaced by a magnetostrictive element) can be made smaller, heat generation can be reduced.

### (Description of Characteristics of Magnetic Flux)

The magnetic flux passing through the mover will be described with reference to FIG. 4C. The direction of the magnetic flux generated by the coils 102a, 102b and the direction of the magnetic flux generated by the magnet 302 are parallel. The magnetic flux passes through the core 201a, 201b and the mover 101, enters the third yoke 401 at the bottom of the mover 101, and enters the magnet 301.

Consequently, the following advantageous effects are provided:
Leakage of the main magnetic flux can be prevented;
The detection sensitivity can be enhanced; and
The second yoke, the coils, or the magnet can be protected.

The magnetic flux passing through the mover 101 is closed. The leakage flux that does not pass the mover 101 contributes little to driving or to the electrical signals of the coils 102a, 102b used for position detection. Therefore, reducing the leakage flux and increasing the magnetic flux passing through the mover 101 is effective for driving and position detection.

Now, the change in the magnetic flux depending on the position of the mover 101 will be described. The change in the magnetic flux with difference in the position of the mover 101 will be described with reference to the side views of FIGS. 6A, 6B, and 6C.

To facilitate the description, the two coils 102a and 102b will be referred to as the coil A and the coil B.

The mover 101 is drawn by broken lines, and the magnetic flux (the main magnetic flux) passing inside the coils and through the mover 101, which relate to driving in the coil A and the coil B, is represented by thick broken lines. FIGS. 6A, 6B, and 6C shows the state in which the mover 101 is located at the left end of the coil A, at the center, and at the right end of the coil B respectively.

The coil A and the coil B have the same size and are arranged in series along the mover 101. The length of the mover 101 is the same as the length of the coil A and the coil B.

To facilitate the description, the number of the thick broken lines in FIGS. 6A, 6B, and 6C represents the total amount of magnetic flux passing through the mover 101. The states shown in FIGS. 6A, 6B, and 6C will be described in order.

FIG. 6A shows the state in which the mover 101 is located at the left end of the coil A. The amount of the main magnetic flux passing inside the coil A is largest, and amount of the main magnetic flux passing inside the coil B is smallest. Actually, a little portion of the main magnetic flux exiting from the mover 101 passes inside the coil B through the air, though the main magnetic flux passing inside the coil B is assumed to be zero in the illustrated case to facilitate explanation.

FIG. 6B shows the state in which the mover 101 is located at the center middle of the coil A and the coil B. The amount of the main magnetic flux passing inside the coil A and the amount of the main magnetic flux passing inside the coil B are substantially equal to each other. At this position of the mover 101, the amount of the main magnetic flux inside each of the coil A and the coil B is approximately half the largest main magnetic flux amount.

FIG. 6C shows the state in which the mover 101 is located at the right end of the coil B. The amount of the main magnetic flux passing inside the coil B is largest, and amount of the main magnetic flux passing inside the coil A is smallest.

As described above, the comparative relationship of the amount of the magnetic flux passing through the mover 101 among the states shown in FIGS. 6A, 6B, and 6C is that the amount of the main magnetic flux passing inside the coil A increases in the order of FIG. 6C, FIG. 6B, and FIG. 6A, and the main magnetic flux passing inside the coil B increases in the order of FIG. 6A, FIG. 6B, and FIG. 6C.

FIG. 7A shows the relationship between the position POS of the mover 101 and the amount of the magnetic flux MG passing through the mover 101 (the main magnetic flux amount), which is described above with reference to FIGS. 6A, 6B, and 6C. The magnetic flux amount CLA of the coil A is represented by the solid line, and the magnetic flux amount CLB of the coil B is represented by the broken line.

When alternating current is supplied to the coils A and B, the amount of the magnetic flux MG passing through the mover 101 changes with the alternating current. This change causes a back electromotive force, which exercises an influence on the coils A, B themselves. Changes in the amount of magnetic flux MG through the mover 101 in the neighborhood of the coils A, B cause changes in the back electromotive force that exercises an influence on the coils A, B themselves.

Therefore, the resistance or inductance of the coils A and B is larger when the amount of main magnetic flux passing through the mover is large than when it is small. Consequently, the change in the resistance or inductance of the coils A and B tends to be similar to the change in the amount of the main magnetic flux passing through the mover 101 shown in FIG. 7A.

FIG. 7B shows the difference DIFF (CLB−CLA) between the main magnetic flux amount through the coil A (CLA) and the main magnetic flux amount through the coil B (CLB) plotted based on the data shown in FIG. 7A. The difference is represented by the thick solid line.

As two coils are used, it is easy to compare the electrical signals of the coil A and the coil B. Moreover, the number of parts can be made small advantageously.

Consequently, the following advantageous effects are provided:
As two coils are used, it is easy to compare the electrical signals of the coils; and
Straight arrangement of the coils makes the assembly easy.

As shown in FIG. 7A, the difference in the main magnetic flux amount between the coil A and coil B has a sensitivity twice higher than that of each coil and changes linearly in relation to the position of the mover 101.

Taking the difference between the signals (e.g. impedances) of the two coils that represent the main magnetic flux amount is advantageous in cancelling electrical noises in the coils.

Consequently, the following advantageous effects are provided:
Taking the difference between the signals of the two coils can cancel noises in the coils.
The differential signal of the two coils generated by taking the difference has a linear relationship to the position of the mover.

Moreover, if the coil A and the coil B have the same size, or the coils include at least two same coils, it is highly probable that the levels of electrical noises are nearly equal among the coil. Thus, cancellation of noises is improved.

Consequently, the following advantageous effects are provided:
Using coils having the same size improves the noise cancellation effect in differential detection; and
Using coils having the same size can lead to a decrease in the number of types of parts.

Actually, a magnetic flux that does not pass through the mover 101 also affects the impedance of the coils. However, the amount of magnetic flux passing through the mover 101 is reflective of the impedance tendency of the coils. For this reason, the change in the electrical signals of the coils depending on the position of the mover 101 has been described in terms of the amount of the main magnetic flux passing through the mover 101.

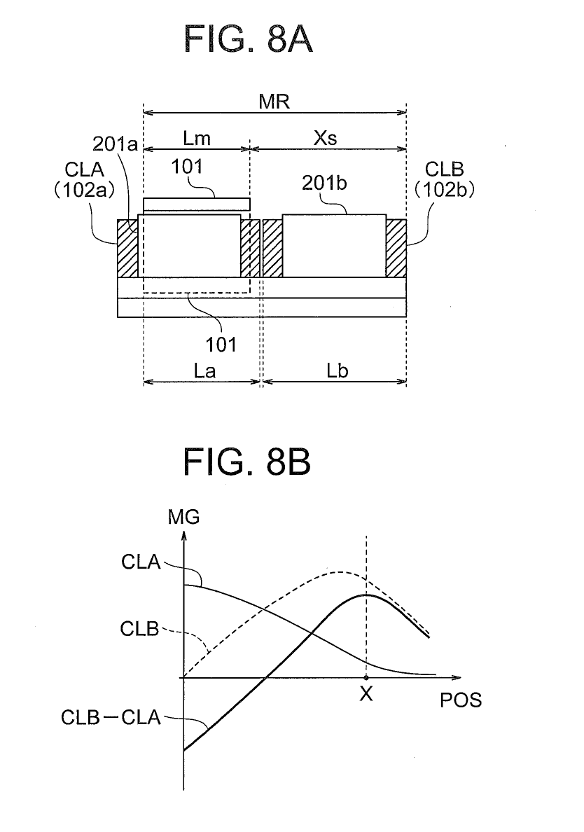

FIGS. 8A and 8B illustrate a case in which the magnetic flux curve has a linear portion and a portion having an extreme.

In a case where the lengths La and Lb of the coils are in the relationship of La<Lb and the length Lm of the mover 101 is shorter than Lb, as the mover 101 moves over the coil B, the main magnetic flux amount through the coil B has an extreme value when the mover is at a certain position above the coil B. Therefore, in the case where the position detection is performed based on the differential signal CLB−CLA between the coil A and coil B, the position of the mover 101 and the electrical signal is not in a one-to-one correspondence. In this case, a complex algorithm is needed. Therefore, it is desirable that the length Lm of the mover 101 be longer than Lb.

In this context, the length of the coil means the length of the range of the coil over which the mover moves.

In this case also, the magnetic flux curve has a linear portion. Thus, it is possible to drive the mover 101 in such a way the linear portion is effectively used without using the extreme portion.

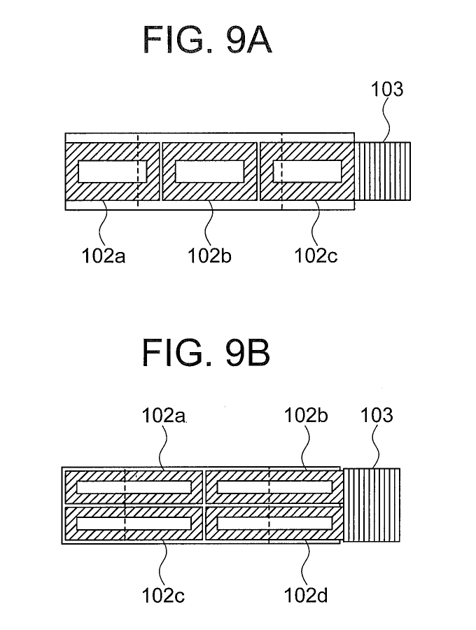

A modification will be described with reference to FIGS. 9A and 9B.

FIG. 9A shows a case in which three coils 102a, 102b, 103c are arranged in series. As the number of coils is increased, while the differential detection algorithm becomes more complex, the accuracy of position detection is improved because of an increase in the number of electrical signals from the coils representing the position of the mover 101. Using three or more coils can provide the same advantage, as will be naturally understood.

FIG. 9B shows a case in which coils 102a, 102b, 102c, 102d are arranged in two parallel rows each of which includes two coils arranged in series. As the number of coils is increased, while the differential detection algorithm becomes more complex, the accuracy of position detection is improved because of an increase in the number of electrical signals from the coils representing the position of the mover 101.

Moreover, since the coils are arranged in parallel, there are two surfaces for attracting the mover 101. This is different from the case in which the magnetic attraction for the mover 101 during driving is provided in one row, where there is one surface for attraction. This arrangement is effecting in preventing inclination of the mover 101.

### INDUSTRIAL APPLICABILITY

The present invention is useful for position detection of the mover in a small-size inertial drive actuator.

The present invention can provide an inertial drive actuator that is small in size and can detect the position of the mover without increasing the size of the actuator.

What is claimed is:

1. An inertial drive actuator comprising:
a displacement unit that generates a small displacement in a first direction and in a second direction opposite to the first direction;
a plurality of coils that generate a magnetic flux in a direction different from the displacement unit;
a mover having a surface facing at least one surface of the plurality of coils and a first yoke that concentrates the magnetic flux generated by the coils to a predetermined location;
a detection unit that detects electrical signals of the plurality of coils that represent changes in the magnetic flux in the neighborhood of the coils depending on positional relationship between the mover and the plurality of coils; and
a determination unit that determines the position of the mover based on an output of the detection unit.

2. An inertial drive actuator according to claim 1, wherein at least two the coils are arranged in series along direction in which the mover is driven.

3. An inertial drive actuator according to claim 1, wherein the determination unit determines the position of the mover using a difference between electrical signals from two coils.

4. An inertial drive actuator according to claim 1, wherein the plurality of coils include at least two same coils.

5. An inertial drive actuator according to claim 1, wherein the detection unit is an impedance measuring circuit.

6. An inertial drive actuator according to claim 1, further comprising a second yoke that is arranged in such a way as to be inserted at least partly inside the plurality of coils.

7. An inertial drive actuator according to claim 1, further comprising a magnet arranged in such a way as to generate a magnetic flux in the direction same as the direction of the magnetic flux generated by the plurality of coils.

8. An inertial drive actuator according to claim 1, further comprising a third yoke which is located in a direction opposite to a direction where the mover and the plurality of coils are faced each other.

9. An inertial drive actuator according to claim 1, further comprising a vibration plate provided between the mover and the plurality of coils, wherein the vibration plate is displaced with displacement of the displacement unit.
